(19) United States
(12) Patent Application Publication
(10) Pub. No.: US 2018/0018312 A1
(43) Pub. Date: Jan. 18, 2018

(54) SYSTEM AND METHOD FOR MONITORING ELECTRONIC DOCUMENTS

(71) Applicant: Vatbox, Ltd., Herzeliya (IL)

(72) Inventors: Noam GUZMAN, Ramat Hasharon (IL); Isaac SAFT, Kfar Neter (IL)

(73) Assignee: Vatbox, Ltd., Herzeliya (IL)

(21) Appl. No.: 15/668,416

(22) Filed: Aug. 3, 2017

Related U.S. Application Data
(63) Continuation-in-part of application No. 15/361,934, filed on Nov. 28, 2016.
(60) Provisional application No. 62/371,234, filed on Aug. 5, 2016.
(60) Provisional application No. 62/260,553, filed on Nov. 29, 2015.
(60) Provisional application No. 62/261,355, filed on Dec. 1, 2015.

(51) Int. Cl. G06F 17/24; G06F 17/30; G06K 9/00; H04L 9/32; G06Q 40/00

(52) U.S. Cl. CPC G06F 17/248; G06F 17/30253; G06F 17/243; G06F 17/30011; G06K 9/00469; G06K 9/00449; G06Q 40/123; H04L 9/3236

(57) ABSTRACT

A system and method for monitoring electronic documents. The method includes analyzing a first electronic document to determine at least one transaction parameter, wherein the first electronic document includes at least partially unstructured data; creating a template for the first electronic document, wherein the created template is a structured dataset including the determined at least one transaction parameter; and comparing data of the created template to data associated with a plurality of second electronic documents to identify at least one abnormality in the first electronic document.

### CROSS-REFERENCE TO RELATED APPLICATIONS

This application claims the benefit of U.S. Provisional Application No. 62/371,234 filed on Aug. 5, 2016. This application is also a continuation-in-part of U.S. patent application Ser. No. 15/361,934 filed on Nov. 28, 2016, now pending, which claims the benefit of U.S. Provisional Application No. 62/260,553 filed on Nov. 29, 2015, and of U.S. Provisional Application No. 62/261,355 filed on Dec. 1, 2015. The contents of the above-referenced applications are hereby incorporated by reference.

### TECHNICAL FIELD

The present disclosure relates generally to monitoring files in data systems, and more particularly to identifying abnormalities in electronic documents.

### BACKGROUND

Due to the rapid growth of technology in recent decades, communications between people all over the world have become increasingly fast and convenient. As a result, transactions which were previously completed over the course of days or weeks can now be completed in a matter of seconds. A given business may now complete thousands or millions of transactions a year. Some of these transactions may be important large-scale transactions.

As businesses increasingly rely on technology to manage data related to operations such as invoice and purchase order data, suitable systems for properly managing and validating data have become crucial to success. Particularly for large businesses, the amount of data utilized daily by businesses can be overwhelming. Accordingly, manual review and validation of such data is impractical, at best. However, disparities between recordkeeping documents can cause significant problems for businesses such as, for example, failure to properly report earnings to tax authorities.

Thus, it is highly desirable for businesses to quickly detect and rectify any abnormalities in company records. This problem may be particularly difficult when a business uses multiple suppliers to provide services and goods, as records from different suppliers may contain different information, may be formatted differently, may contain errors or sudden changes in price, and the like. Further, identifying abnormalities may be challenging when company records are received in unstructured data formats. For example, invoices are often received as image files showing a scan of an invoice.

Some solutions exist for automatically recognizing information in scanned documents (e.g., invoices and receipts) or other unstructured electronic documents (e.g., unstructured text files). Such solutions often face challenges in accurately identifying and recognizing characters and other features of electronic documents. Moreover, degradation in content of the input unstructured electronic documents typically result in higher error rates. As a result, existing image recognition techniques are not completely accurate under ideal circumstances (i.e., very clear images), and their accuracy often decreases dramatically when input images are less clear. Moreover, missing or otherwise incomplete data can result in errors during subsequent use of the data. Many existing solutions cannot identify missing data unless, e.g., a field in a structured dataset is left incomplete.

In addition, existing image recognition solutions may be unable to accurately identify some or all special characters (e.g., “!,” “@,” “#,” “$,” “©,” “%,” “&,” etc.). As an example, some existing image recognition solutions may inaccurately identify a dash included in a scanned receipt as the number “1.” As another example, some existing image recognition solutions cannot identify special characters such as the dollar sign, the yen symbol, etc.

Further, such solutions may face challenges in preparing recognized information for subsequent use. Specifically, many such solutions either produce output in an unstructured format, or can only produce structured output if the input electronic documents are specifically formatted for recognition by an image recognition system. The resulting unstructured output typically cannot be processed efficiently. In particular, such unstructured output may contain duplicates, and may include data that requires subsequent processing prior to use.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a method for monitoring electronic documents. The method comprises: analyzing a first electronic document to determine at least one transaction parameter, wherein the first electronic document includes at least partially unstructured data; creating a template for the first electronic document, wherein the created template is a structured dataset including the determined at least one transaction parameter; and comparing data of the created template to data associated with a plurality of second electronic documents to identify at least one abnormality in the first electronic document.

Certain embodiments disclosed herein also include a non-transitory computer readable medium having stored thereon instructions for causing a processing circuitry to perform a process, the process comprising: analyzing a first electronic document to determine at least one transaction parameter, wherein the first electronic document includes at least partially unstructured data; creating a template for the first electronic document, wherein the created template is a structured dataset including the determined at least one transaction parameter; and comparing data of the created template to data associated with a plurality of second electronic documents to identify at least one abnormality in the first electronic document.

Certain embodiments disclosed herein also include a system for monitoring electronic documents. The system comprises: a processing circuitry; and a memory, the memory containing instructions that, when executed by the processing circuitry, configure the system to: analyze a first electronic document to determine at least one transaction parameter, wherein the first electronic document includes at least partially unstructured data; create a template for the first electronic document, wherein the created template is a structured dataset including the determined at least one transaction parameter; and compare data of the created template to data associated with a plurality of second electronic documents to identify at least one abnormality in the first electronic document.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of a validation system according to an embodiment.

FIG. 3 is a flowchart illustrating a method for monitoring electronic documents according to an embodiment.

FIG. 4 is a flowchart illustrating a method for creating a dataset based on at least one electronic document according to an embodiment.

FIG. 5 is a flowchart illustrating a method for identifying abnormalities based on a template created for an input electronic document according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for monitoring electronic documents. The embodiments disclosed herein may be utilized to detect and correct abnormalities in the monitored electronic documents. In an embodiment, a dataset is created based on a first input electronic document. The input electronic document includes data of a transaction and may include unstructured data. A template of transaction attributes is created based on the input electronic document dataset. Data of the template created for the input electronic document is compared to data of second sample electronic documents. Based on the comparison, one or more abnormalities in data values may be identified. An alert indicating the abnormalities may be generated.

The disclosed embodiments allow for automatic identification of abnormalities in, for example, newly received invoices. More specifically, the disclosed embodiments include providing structured dataset templates for electronic documents, thereby allowing for efficiently and accurately comparing data included in electronic documents that are unstructured, semi-structured, or otherwise lacking a known structure. Further, the templates created for the electronic documents allow for more efficient comparisons of particular sets of data, as comparisons may be limited to comparisons among particular fields of the templates. For example, data in a “time” field of a template may be compared to data in “time” fields of other templates without requiring comparison to other data.

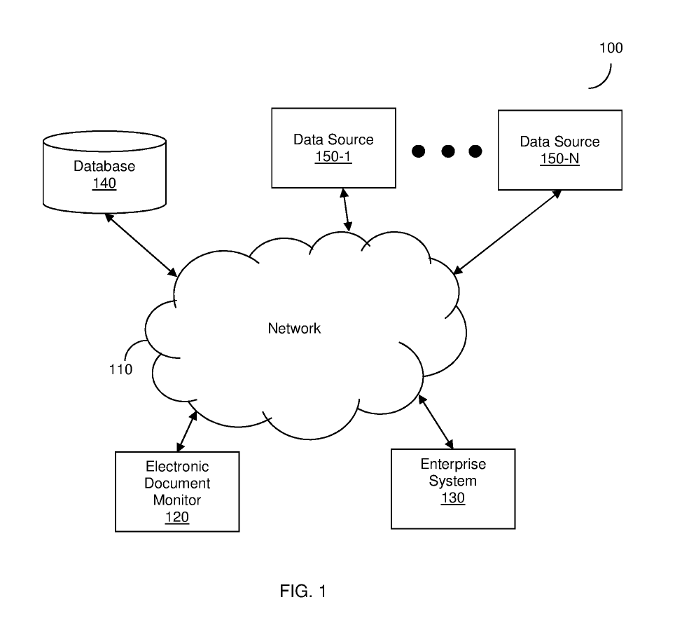

FIG. 1 shows an example network diagram 100 utilized to describe the various disclosed embodiments. In the example network diagram 100, an electronic document monitor 120, an enterprise system 130, a database 140, and a plurality of data sources 150-1 through 150-N (hereinafter referred to individually as a data source 150 and collectively as data sources 150, merely for simplicity purposes), are communicatively connected via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The enterprise system 130 is associated with an enterprise, and may store data related to purchases made by the enterprise or representatives of the enterprise as well as data related to the enterprise itself. The enterprise may be, but is not limited to, a business whose employees may purchase goods and services subject to VAT taxes while abroad. The enterprise system 130 may be, but is not limited to, a server, a database, an enterprise resource planning system, a customer relationship management system, or any other system storing relevant data.

The data stored by the enterprise system 130 may include, but is not limited to, electronic documents (e.g., an image file showing, for example, a scan of an invoice, a text file, a spreadsheet file, etc.). Each electronic document may show, e.g., an invoice, a tax receipt, a purchase number record, a VAT reclaim request, and the like. Data included in each electronic document may be structured, semi-structured, unstructured, or a combination thereof. The structured or semi-structured data may be in a format that is not recognized by the electronic document monitor 120 and, therefore, may be treated as unstructured data.

The database 140 may store templates created for electronic documents as well as historical data related to data value patterns and abnormality data indicating deviations from data value patterns identified by the electronic document monitor 120.

The data sources 150 store at least electronic documents that may be utilized as evidence for granting requests. The data sources 150 may include, but are not limited to, servers or devices of merchants, tax authority servers, accounting servers, a database associated with an enterprise, and the like. As a non-limiting example, the data source 150-1 may be a merchant server storing image files showing invoices for transactions made by a merchant associated with the merchant server.

In an embodiment, the electronic document monitor 120 is configured to create a template based on transaction parameters identified using machine vision of a first input electronic document indicating information related to a transaction. Each template includes one or more fields and corresponding key values identified in the analyzed electronic document. To this end, the electronic document monitor 120 may be configured to retrieve the input electronic document from, for example, one of the data sources 150 or the enterprise system 130. The electronic document monitor 120 is configured to compare data of the created template to data of second sample electronic documents. The data of the second sample electronic documents may be included in templates created for the sample electronic documents. Thus, the comparison may be made with respect to data of certain fields in the templates.

Based on the comparison, the electronic document monitor 120 is configured to identify abnormalities in data values of the input electronic document. For example, an abnormality may be an abnormal value for price indicated in the input electronic documents as compared to prices indicated in the sample electronic documents. The abnormalities may be identified by determining deviations of values of data of the input electronic document from, for example, average values of the sample electronic documents above a threshold. The threshold may be a predetermined threshold, and may be a threshold value (a number, a character, or a word), or may be a threshold proportion (e.g., plus or minus 5% of the average).

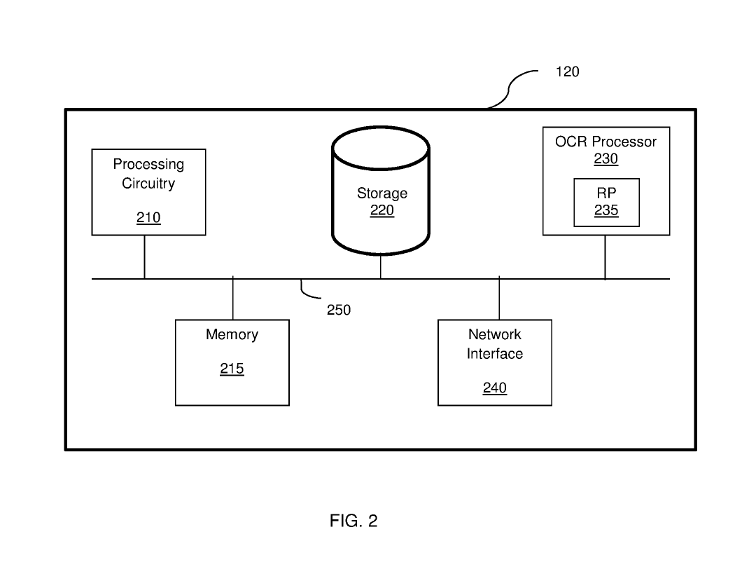

In an embodiment, the electronic document monitor 120 is configured to create datasets based on electronic documents including data at least partially lacking a known structure (e.g., unstructured data, semi-structured data, or structured data having an unknown structure). To this end, the electronic document monitor 120 may be further configured to utilize optical character recognition (OCR) or other image processing to determine data in the electronic document. The electronic document monitor 120 may therefore include or be communicatively connected to a recognition processor (e.g., the recognition processor 235, FIG. 2).

The electronic document monitor 120 is configured to analyze the created datasets to identify transaction parameters related to transactions indicated in the electronic documents. Based on the transaction parameters of the created datasets, the electronic document monitor is configured to create a template for each analyzed electronic document. Each template is a structured dataset including the identified transaction parameters for a transaction.

Using structured templates for identifying abnormalities allows for more efficient and accurate identification of abnormalities than, for example, by utilizing unstructured data. Specifically, portions of an input electronic document may be compared only to corresponding portions of sample electronic documents (e.g., portions included in specific fields of a structured template), thereby reducing the amount of data to be compared as well as reducing false positives due to comparing unrelated data. Further, data extracted from electronic documents and organized into templates requires less memory than, for example, images of scanned documents.

Based on the template created for the input electronic document, the electronic document monitor 120 may be configured to retrieve the sample electronic documents to be compared. Retrieving the sample electronic documents may include searching in the enterprise system 130 based on data in the input electronic document template. As a non-limiting example, if data in the input electronic document template indicates a purchase from a particular seller, the sample electronic documents may be retrieved by searching with respect to the seller. As another non-limiting example, if data in the input electronic document template indicates a purchase of a particular type of good, the sample electronic documents made be retrieved by searching with respect to the type of good.

In yet another embodiment, the electronic document monitor 120 may be further configured to validate the input electronic document based on the created template for the input electronic document. The validation may include, but is not limited to, determining whether each of the input electronic document is complete.

The input electronic document may be determined to be complete if, for example, one or more predetermined required fields of the template include data. For example, the input electronic document may be complete if at least a time, a seller ID, and a price field of the template created for the input electronic document include data.

It should be noted that the embodiments described herein above with respect to FIG. 1 are described with respect to one enterprise system 130 merely for simplicity purposes and without limitation on the disclosed embodiments. Multiple enterprise systems may be equally utilized without departing from the scope of the disclosure. Different groups of sample electronic documents may be utilized for different enterprises, thereby ensuring accuracy and security of data comparisons.

FIG. 2 is an example schematic diagram of the electronic document monitor 120 according to an embodiment. The electronic document monitor 120 includes a processing circuitry 210 coupled to a memory 215, a storage 220, and a network interface 240. In an embodiment, the electronic document monitor 120 may include an optical character recognition (OCR) processor 230. The components of the electronic document monitor 120 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 215 may be volatile (e.g., RAM, etc.), non-volatile (e.g., ROM, flash memory, etc.), or a combination thereof. In one configuration, computer readable instructions to implement one or more embodiments disclosed herein may be stored in the storage 220.

In another embodiment, the memory 215 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 210 to perform the various processes described herein. Specifically, the instructions, when executed, cause the processing circuitry 210 to monitor electronic documents, as discussed herein.

The storage 220 may be magnetic storage, optical storage, and the like, and may be realized, for example, as flash memory or other memory technology, CD-ROM, Digital Versatile Disks (DVDs), or any other medium which can be used to store the desired information.

The OCR processor 230 may include, but is not limited to, a feature and/or pattern recognition processor (RP) 235 configured to identify patterns, features, or both, in unstructured data sets. Specifically, in an embodiment, the OCR processor 230 is configured to identify at least characters in the unstructured data. The identified characters may be utilized to create a dataset including data required for verification of a request.

The network interface 240 allows the electronic document monitor 120 to communicate with the enterprise system 130, the database 140, the data sources 150, or a combination of, for the purpose of, for example, retrieving and receiving electronic documents, storing data, sending notifications, and the like.

It should be understood that the embodiments described herein are not limited to the specific architecture illustrated in FIG. 2, and other architectures may be equally used without departing from the scope of the disclosed embodiments.

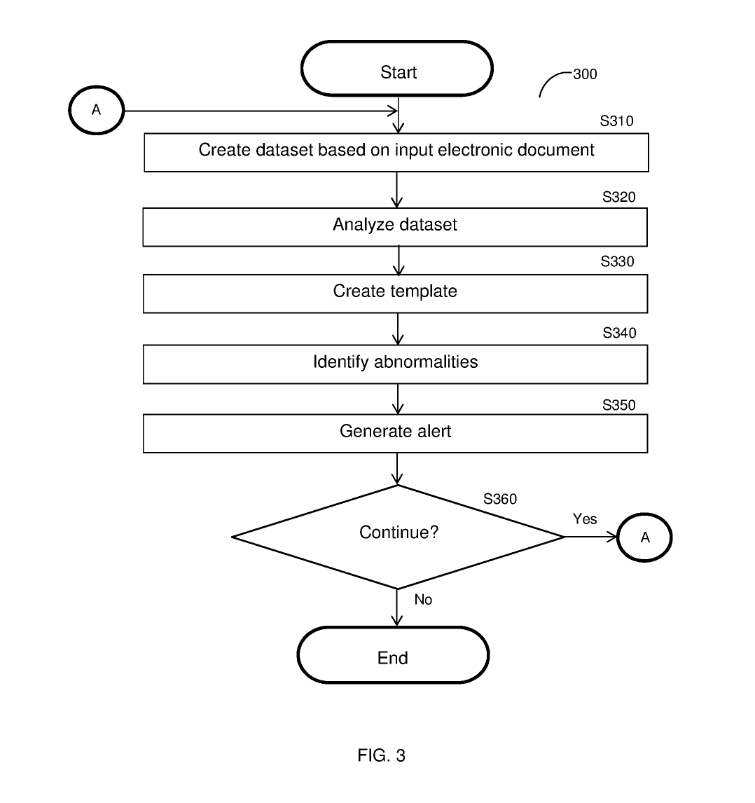

FIG. 3 is an example flowchart 300 illustrating a method for monitoring electronic documents according to an embodiment. In an embodiment, the method may be performed by the electronic document monitor 120.

At S310, a dataset is created based on an input electronic document including information related to a transaction. The input electronic document may include, but is not limited to, unstructured data, semi-structured data, structured data with structure that is unanticipated or unannounced, or a combination thereof. In an example implementation, the input electronic document may be an electronic invoice. The dataset may include, for example, a transaction amount of 100 USD, a time pointer indicating the date Jan. 1, 2016, and a name of a supplier “ABC Shipping Co.”

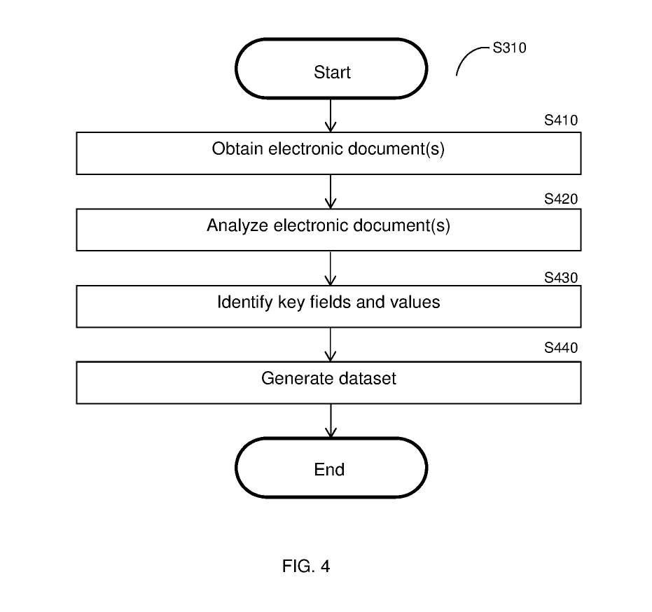

In an embodiment, S310 includes analyzing the input electronic document using optical character recognition (OCR) to determine data in the input electronic document, identifying key fields in the data, identifying values in the data, or a combination thereof. Creating datasets based on electronic documents is described further herein below with respect to FIG. 4.

At S320, the input electronic document dataset is analyzed. In an embodiment, analyzing the input dataset may include, but is not limited to, determining transaction parameters such as, but not limited to, at least one entity identifier (e.g., a consumer enterprise identifier, a merchant enterprise identifier, or both), information related to the transaction (e.g., a date, a time, a price, a type of good or service sold, etc.), or both. In an example implementation, the determined transaction parameters include at least a transaction amount (e.g., a price, quantity, or both), a time pointer, and a supplier identifier (e.g., a name or identification number). For example, the transaction parameters may include the transaction amount, time pointer, and supplier name.

At S330, a template is created based on the input electronic document dataset. The template may be, but is not limited to, a data structure including a plurality of fields. The fields may include the identified transaction parameters. The fields may be predefined.

Creating templates from electronic documents allows for faster processing due to the structured nature of the created templates. For example, query and manipulation operations may be performed more efficiently on structured datasets than on datasets lacking such structure. Further, organizing information from electronic documents into structured datasets, the amount of storage required for saving information contained in electronic documents may be significantly reduced. Electronic documents are often images that require more storage space than datasets containing the same information. For example, datasets representing data from 100,000 image electronic documents can be saved as data records in a text file. A size of such a text file would be significantly less than the size of the 100,000 images.

At S340, data of the created template for the input electronic document is compared to data associated with a plurality of sample electronic documents to identify one or more abnormalities in the input electronic document. The abnormalities may be abnormal values of data in the template created for the input electronic document. Each of the sample electronic documents includes data of a transaction. In an example implementation, the sample electronic documents include images showing scanned invoices for previous transactions made by an enterprise.

The data of the created template may be compared to corresponding data of the group of sample electronic documents directly, or may be compared to one or more representative data for the group of sample electronic documents. The representative data may include, but is not limited to, an average, a standard deviation, a median, a mode, and the like.

The data of the input electronic document template may be compared to data of one or more select groups of sample electronic documents (e.g., a group selected from a database of sample electronic documents), thereby allowing for identifying abnormalities with respect to different normal data value patterns. For example, data of the input electronic document may be compared to a first group of sample electronic documents showing transactions related to a certain seller and to a second group of sample electronic documents showing transactions for the same product.

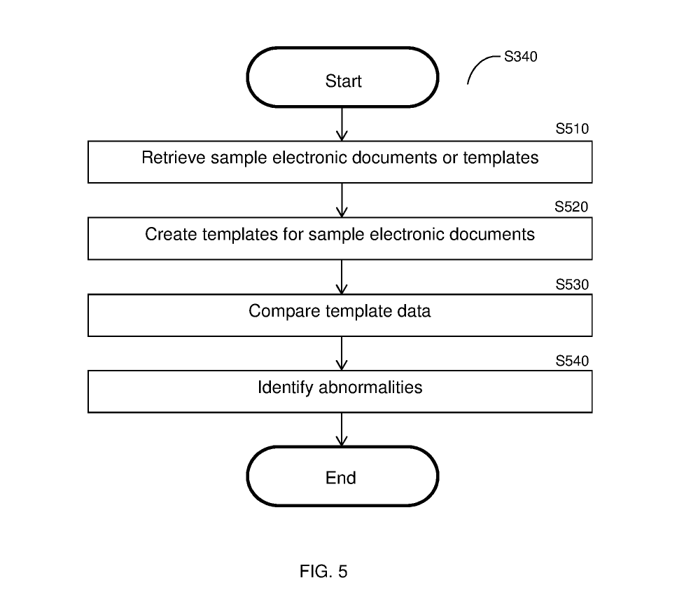

Identifying abnormalities in an input electronic document based on data of sample electronic documents is described further herein below with respect to FIG. 5.

At S350, when one or more abnormalities is identified, an alert is generated. The alert may indicate the identified abnormalities and the anomalous input electronic document. The alert may be sent to, for example, the enterprise system 130, FIG. 1, or a user device associated with an enterprise. In some implementations, if S340 resulted in a null value (i.e., if no anomalies were detected), no alert may be generated.

At S360, it is checked if additional input electronic documents are to be analyzed for abnormalities and, if so, execution continues with S310; otherwise, execution terminates. In some implementations, input electronic documents may be monitored for abnormalities in real-time as they are received such that abnormalities are identified and alerts are generated nearly immediately after receipt of new input electronic documents.

As a non-limiting example, an electronic invoice illustrating a purchase of cocoa beans by a candy company is received. A dataset including an amount paid for the cocoa beans of 340 USD, a timestamp of Feb. 9, 2016, and a seller name “Bean Harvesters, Inc.” is created. The dataset is analyzed to determine the transaction parameters in the dataset. A template including the determined transaction parameters is created. The template includes fields “Purchase Price,” “Date of Purchase,” and “Seller Name,” each field including the respective transaction parameters related to the 340 USD price, the date Feb. 9, 2016, and the “Bean Harvesters, Inc.” name.

The 340 USD price is compared to an average price of 125 USD associated with a group of sample electronic documents showing purchases from Bean Harvesters during December 2015 and January 2016. The group of sample electronic documents include purchase prices of 114 USD, 117 USD, 125 USD, 133 USD, and 136 USD, respectively. Based on the comparison, it is determined that the price of the Feb. 9, 2016, purchase is above a threshold value of 100 USD away from the average price and, therefore, that an abnormal price has been identified. An alert indicating that the Feb. 9, 2016, invoice is abnormal is generated and sent for review.

FIG. 4 is an example flowchart S310 illustrating a method for creating a dataset based on an electronic document according to an embodiment.

At S410, the electronic document is obtained. Obtaining the electronic document may include, but is not limited to, receiving the electronic document (e.g., receiving a scanned image) or retrieving the electronic document (e.g., retrieving the electronic document from a consumer enterprise system, a merchant enterprise system, or a database).

At S420, the electronic document is analyzed. The analysis may include, but is not limited to, using optical character recognition (OCR) to determine characters in the electronic document.

At S430, based on the analysis, key fields and values in the electronic document are identified. The key field may include, but are not limited to, merchant's name and address, date, currency, good or service sold, a transaction identifier, an invoice number, and so on. An electronic document may include unnecessary details that would not be considered to be key values. As an example, a logo of the merchant may not be required and, thus, is not a key value. In an embodiment, a list of key fields may be predefined, and pieces of data that may match the key fields are extracted. Then, a cleaning process is performed to ensure that the information is accurately presented. For example, if the OCR would result in a data presented as “1211212005”, the cleaning process will convert this data to Dec. 12, 2005. As another example, if a name is presented as “Mo$den”, this will change to “Mosden”. The cleaning process may be performed using external information resources, such as dictionaries, calendars, and the like.

In a further embodiment, it is checked if the extracted pieces of data are completed. For example, if the merchant name can be identified but its address is missing, then the key field for the merchant address is incomplete. An attempt to complete the missing key field values is performed. This attempt may include querying external systems and databases, correlation with previously analyzed invoices, or a combination thereof. Examples for external systems and databases may include business directories, Universal Product Code (UPC) databases, parcel delivery and tracking systems, and so on. In an embodiment, S430 results in a complete set of the predefined key fields and their respective values.

At S440, a structured dataset is generated. The structured dataset includes the identified key fields and values.

FIG. 5 is an example flowchart S340 illustrating a method for identifying abnormalities based on a template created for an input electronic document according to an embodiment.

At S510, sample electronic documents or templates of sample electronic documents are retrieved. The sample electronic documents may be retrieved based on data indicated in one or more fields of the template created for the input electronic document.

In an example implementation, each retrieved group of sample electronic documents may include electronic documents related to the same merchant, to the same type of goods or services purchased, using the same method of payment (e.g., a particular credit card number), periods of time, to a combination thereof (for example, electronic documents indicating purchases from the same merchant during the first week of each month), and the like. Comparing data of an input electronic document to data of sample electronic documents sharing common parameters may allow for increased efficiency of identifying abnormalities when the shared parameter is likely indicative of consistent data patterns. For example, purchases from the same merchant may be expected to be consistently around the same price such that, if previous purchases from a specific merchant have an average price of $1,000 for the enterprise, a purchase price of $1,400 from that merchant may indicate an abnormality. The data of the input electronic document may be compared to data of multiple groups of sample electronic documents, thereby allowing for identifying anomalies with respect to different potential sources of abnormalities and, consequently, identifying a more complete set of abnormalities for the input electronic document.

To this end, in an embodiment, S510 may include searching, based on data in the input electronic document template, in one or more data sources for the sample electronic documents to which the input electronic document should be compared. As a non-limiting example, a merchant identifier number “12345” indicated in a “Merchant ID” field of the input electronic document template may be utilized as a search query to find the sample electronic documents based on, e.g., metadata of sample electronic documents including the merchant identification number “12345.” As a result, only data of sample electronic documents for transactions involving the same merchant are compared to the input electronic document.

At optional S520, a template may be created for each sample electronic document.

Each template is a structured electronic document including transaction parameters indicated in the sample electronic document. Creating templates for sample electronic documents may allow for conserving computing resources, as the templates, when stored, may require less memory than the original sample electronic documents, for example image files.

At S530, data of the input electronic document is compared to data of each group of sample electronic documents. Comparing data of the created sample electronic document templates to data of the input electronic document allows for more efficient comparison of data than, for example, by comparing unstructured or otherwise unorganized data. Specifically, data may be compared with respect to particular fields of the templates rather than comparing, e.g., all data of the input electronic document to all data of the groups of sample electronic documents. In an example implementation, data indicated in a “price” field, in a “quantity” field, or both, of the input electronic document may be compared to corresponding data of the sample electronic documents. The corresponding data may include data indicated in corresponding fields of the templates for the sample electronic documents, or data that is otherwise representative of the sample electronic documents (e.g., average values, most often appearing values, median values, and the like). To this end, S530 may include selecting one or more representative values of the sample electronic documents for comparison to one or more corresponding values of the template of the input electronic document based on the fields including the corresponding input electronic document values.

At S540, based on the comparison, one or more abnormalities may be identified. The abnormalities may be identified based on one or more thresholds, and different thresholds may be applied for, e.g., different compared transaction parameters (e.g., a threshold for price may be different from a threshold for quantity). If the comparison did not result in any deviations above the respective thresholds, S540 may result in a null value (i.e., indicating no abnormalities).

Each abnormality is identified based on deviation of a transaction parameter of the input electronic document from the transaction parameters of one of the groups of sample electronic documents above the threshold. The threshold may be a value (e.g., a number, a word, a character, etc.), a proportion, and the like. The deviation may be determined based on deviation from one of the values from any of the sample electronic documents, or may be determined based on a deviation from an average or otherwise representative value for the sample electronic documents. For example, for an average of 2,000 watermelons ordered per month as indicated in “quantity” fields of sample electronic documents, an input electronic document template indicating 10,000 watermelons in a “quantity” field may indicate a deviation and, therefore, an abnormality.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for monitoring electronic documents, comprising:
analyzing a first electronic document to determine at least one transaction parameter, wherein the first electronic document includes at least partially unstructured data;
creating a template for the first electronic document, wherein the created template is a structured dataset including the determined at least one transaction parameter; and
comparing data of the created template to data associated with a plurality of second electronic documents to identify at least one abnormality in the first electronic document.

2. The method of claim 1, wherein determining the at least one transaction parameter further comprises:
identifying, in the first electronic document, at least one key field and at least one value;
creating, based on the first electronic document, a dataset, wherein the created dataset includes the at least one key field and the at least one value; and
analyzing the created dataset, wherein the at least one transaction parameter is determined based on the analysis.

3. The method of claim 2, wherein identifying the at least one key field and the at least one value further comprises:
analyzing the first electronic document to determine data in the first electronic document; and
extracting, based on a predetermined list of key fields, at least a portion of the determined data, wherein the at least a portion of the determined data matches at least one key field of the predetermined list of key fields.

4. The method of claim 3, wherein analyzing the first electronic document further comprises:
performing optical character recognition on the first electronic document.

5. The method of claim 1, wherein comparing data of the created template to data associated with a plurality of second electronic documents further comprises:
comparing a first value of the at least one transaction parameter to a second value associated with the plurality of second electronic documents, wherein an abnormality is identified when the difference between the first value and the second value at least meets a threshold.

6. The method of claim 5, wherein the second value is selected for comparison based on the field of the template that includes the first value.

7. The method of claim 1, further comprising:
generating an alert indicating the identified at least one abnormality.

8. The method of claim 1, wherein the at least one transaction parameter includes a transaction amount, a time pointer, and a supplier identifier, wherein the at least one abnormality includes an abnormal value of the transaction amount as compared to transaction amounts indicated in the second electronic documents.

9. The method of claim 1, wherein each electronic document is an electronic invoice.

10. A non-transitory computer readable medium having stored thereon instructions for causing a processing circuitry to perform a process, the process comprising:
analyzing a first electronic document to determine at least one transaction parameter, wherein the first electronic document includes at least partially unstructured data;
creating a template for the first electronic document, wherein the created template is a structured dataset including the determined at least one transaction parameter; and
comparing data of the created template to data associated with a plurality of second electronic documents to identify at least one abnormality in the first electronic document.

11. A system for validating a transaction represented by an electronic document, comprising:
a processing circuitry; and
a memory, the memory containing instructions that, when executed by the processing circuitry, configure the system to:
analyze a first electronic document to determine at least one transaction parameter, wherein the first electronic document includes at least partially unstructured data;
create a template for the first electronic document, wherein the created template is a structured dataset including the determined at least one transaction parameter; and
compare data of the created template to data associated with a plurality of second electronic documents to identify at least one abnormality in the first electronic document.

12. The system of claim 11, wherein the system is further configured to:
identify, in the first electronic document, at least one key field and at least one value;
create, based on the first electronic document, a dataset, wherein the created dataset includes the at least one key field and the at least one value; and
analyze the created dataset, wherein the at least one transaction parameter is determined based on the analysis.

13. The system of claim 12, wherein the system is further configured to:
analyze the first electronic document to determine data in the first electronic document; and
extract, based on a predetermined list of key fields, at least a portion of the determined data, wherein the at least a portion of the determined data matches at least one key field of the predetermined list of key fields.

14. The system of claim 13, wherein the system is further configured to:
perform optical character recognition on the first electronic document.

15. The system of claim 11, wherein the system is further configured to:
compare a first value of the at least one transaction parameter to a second value associated with the plurality of second electronic documents, wherein an abnormality is identified when the difference between the first value and the second value at least meets a threshold.

16. The system of claim 15, wherein the second value is selected for comparison based on the field of the template that includes the first value.

17. The system of claim 11, wherein the system is further configured to:
retrieve, based on the at least one transaction parameter, the plurality of second electronic documents.

18. The system of claim 11, wherein the system is further configured to:
generate an alert indicating the identified at least one abnormality.

19. The system of claim 11, wherein the at least one transaction parameter includes a transaction amount, a time pointer, and a supplier identifier, wherein the at least one abnormality includes an abnormal value of the transaction amount as compared to transaction amounts indicated in the second electronic documents.
